(19) United States
(12) Patent Application Publication
(10) Pub. No.: US 2013/0011125 A1
(43) Pub. Date: Jan. 10, 2013

(54) Rolling lumens heating systems(5)

(76) Inventor: Charles Edmund Souders, Rochester Hills, MI (US)

(21) Appl. No.: 12/932,557

(22) Filed: Jul. 7, 2011

(51) Int. Cl. F27D 11/12

(52) U.S. Cl. 392/411

(57) ABSTRACT

This is an invention which replaces the costly use of combustible fuels to provide heating for all types of structures including homes, businesses, commercial buildings and various other types of structures. By eliminating the use of combustible fuels, the cost to the consumer is significantly reduced and the amount of pollutants released into the atmosphere is eliminated as well. The “Rolling Lumens Heater” utilizes the lumens generated by light bulbs to heat the air in a chamber which is then pushed by a fan into the area which requires heat. The end result is an area which is heated to and maintains a temperature of 70 degrees.

This application claims the benefit of provisional patent application Ser. No. 61/208,268, filed 2009 Feb. 23 by the present inventor.

### BACKGROUND

1. Field of Invention

This invention relates to the generation of heat to be used in heating systems such as are used to provide heat in residences, businesses, and other structures.

2. Prior Art

Historically, structures have required some form of heating system to heat the interior of the structure when ambient temperatures descended to the point that the inhabitants of the structure became uncomfortable. These heating systems have relied on the combustion of various types of fuels, such as oil, natural gas, propane, or coal, to provide the desired heat which resulted in a comfortable environmental temperature. The by-product of the combustion of these fuels results in environmental pollution which presents a health hazard. In addition, the cost of these fuels, particularly, oil, is inordinately high. As a result, the cost of heating a structure, such as a residence, is inordinately high for the consumer. A high percentage of the oil used is imported from foreign countries which results in the United States being dependent on those countries to provide us with the oil required to meet our needs. A massive reduction in the amount of oil used for heating purposes would significantly diminish this country's dependence on foreign oil.

### SUMMARY

Current heating systems which utilize fossil fuel, gas, or petroleum, pollute our atmosphere, create health hazards, and are far too costly placing an undue financial burden on the consumer.

### DRAWINGS

FIG. 1 shows the “Rolling Lumens Heater” as a self standing heating source.

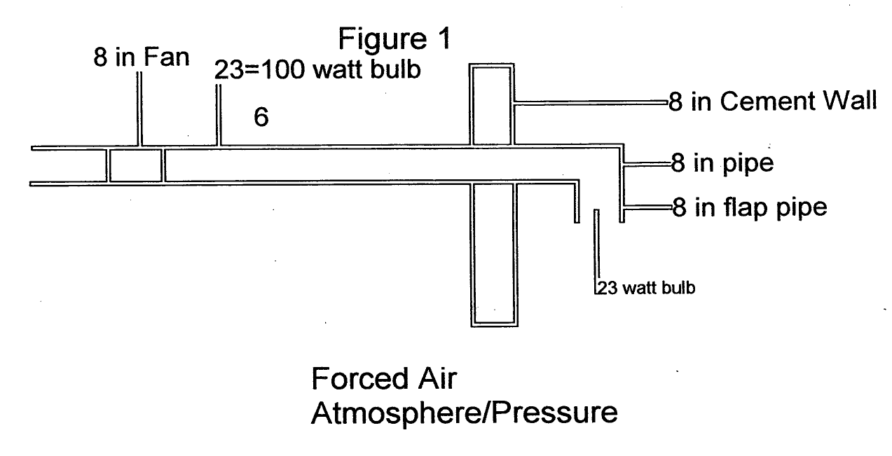

FIG. 2 shows the “Rolling Lumens Heater” used as the heat source for a baseboard hot water heating system.

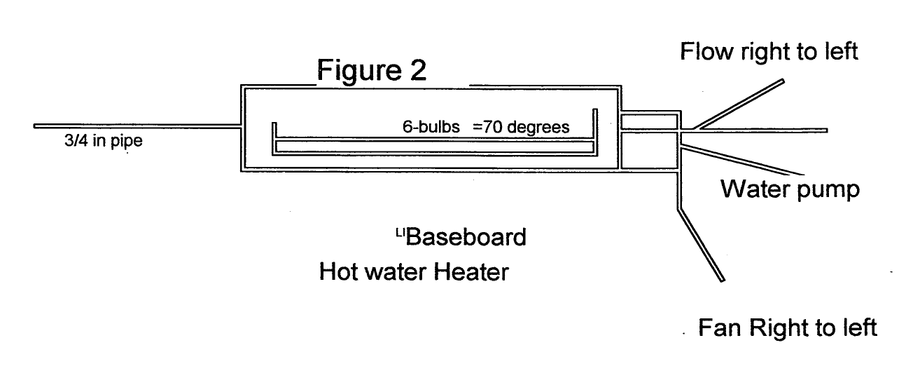

FIG. 3 shows the “Rolling Lumens Heater” used in the cold air return of a forced air furnace

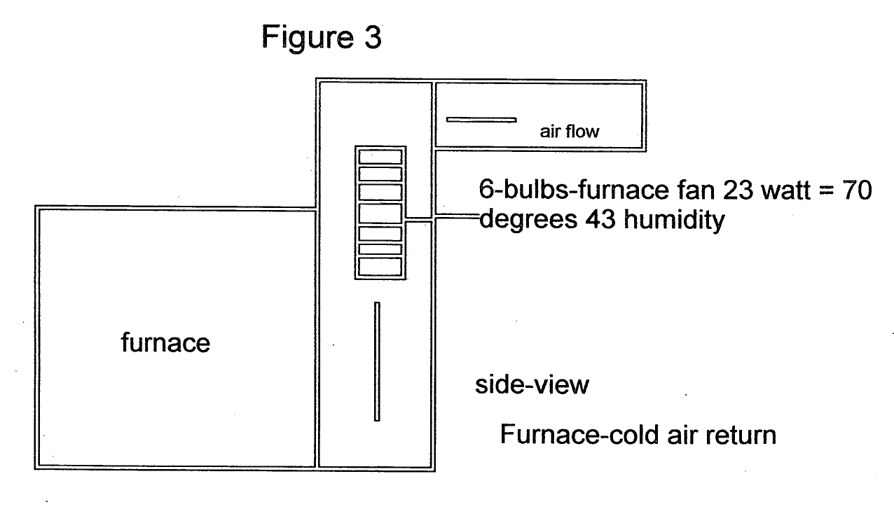

FIG. 4 shows the “Rolling Lumens Heater” as the heat source for a hot water line heater

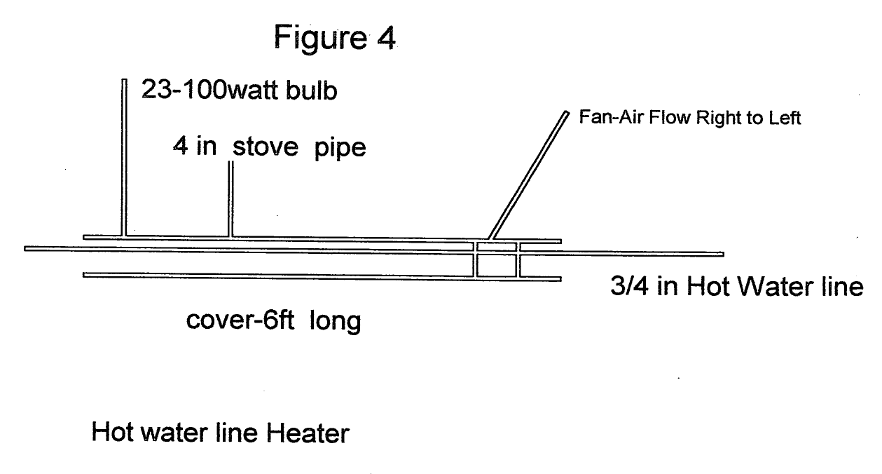

FIG. 5 shows a portable “Rolling Lumens Heater”.

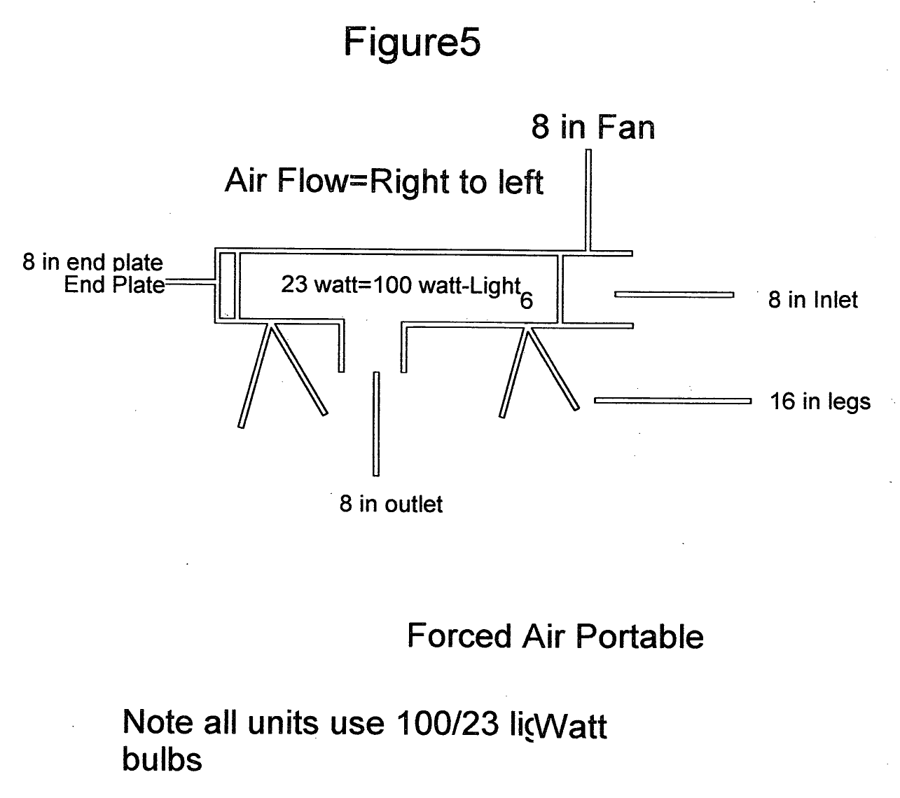

### DETAILED DESCRIPTION

The “Rolling Lumens Heater” consists of an 8″×8″×4″ electrical junction box with six lampholders mounted on the exterior of the box. A 100 watt light bulb is placed in each of the lampholders. A 120 volt ac line supplies voltage to the interior of the junction box where each of the lampholders is connected in parallel to the line. The junction box is installed in the cold air return of a forced air furnace or in an enclosure through which hot water pipes travel in a hot water heating system. When the lamps are illuminated, the air driven by an 8 inch fan through the cold air return, or enclosure, is heated to a temperature of 70 degrees Fahrenheit. The heated air is then pushed through the heating system to the registers and out into the rooms where the temperature remains constant at 70 degrees. The cost of operating this system is approximately $30.00 per month for an average size home. No petroleum or fossil fuels are burned in this process with no resultant environmental pollution and inherent health hazards.

I claim:

1. A method of heating comprising irradiating the air in a chamber with lumens.

2. The chamber of claim 1 contains an enclosure made of metal or non-conductive material.

3. The enclosure of claim 2 has multiple electric lampholders mounted on its exterior.

4. The lampholders of claim 3 contain light bulbs.

5. The interior of the enclosure of claim 2 is supplied with a 120 volt alternating current source

6. Within the enclosure in claim 2, the leads from the lampholders in claim 3 are connected in parallel with the 120 volt alternating current source in claim 5.

7. The chamber of claim 1 is equipped with an 8 inch fan which is connected to a 120 volt alternating current source.

8. The chamber of claim 1 has an opening to direct the heated air to the desired location.
